(19) United States
(12) Patent Application Publication
(10) Pub. No.: US 2018/0006809 A1
(43) Pub. Date: Jan. 4, 2018

(54) DATA SECURITY IN A CLOUD NETWORK

(71) Applicant: Intel Corporation, Santa Clara, CA (US)

(72) Inventors: Vincent R. Scarlata, Beaverton, OR (US); Francis X. McKeen, Portland, OR (US); Carlos V. Rozas, Portland, OR (US); Simon P. Johnson, Beaverton, OR (US); Bo Zhang, Raleigh, NC (US); Mona Vij, Hillsboro, OR (US); Brandon Baker, Portland, OR (US); Mohan J. Kumar, Aloha, OR (US); Asit K. Mallick, Saratoga, CA (US); Mark A. Gentry, Raleigh, NC (US); Somnath Chakrabarti, Portland, OR (US)

(73) Assignee: Intel Corporation, Santa Clara, CA (US)

(21) Appl. No.: 15/200,604

(22) Filed: Jul. 1, 2016

(51) Int. Cl. H04L 9/08; H04L 29/06; G06F 21/62

(52) U.S. Cl. CPC H04L 9/0816; G06F 21/6218; H04L 63/06

(57) ABSTRACT

Particular embodiments described herein provide for an electronic device that can be configured to store data in a secure domain in a cloud network, create encryption keys, where each encryption key is to provide a different type of access to the data, and store the encryption keys in a secure domain key store in the cloud network. In an example, each encryption key provides access to a different version of the data. In another example, a counter engine stores the location of each version of the data in the cloud network.

### TECHNICAL FIELD

This disclosure relates in general to the field of information security, and more particularly, to data security in a cloud network.

### BACKGROUND

The field of network security has become increasingly important in today's society. In particular, a cloud network can provide a medium for exchanging data between different devices connected to different computer networks. While the use of a network has transformed business and personal communications, it has also been used as a vehicle for malicious operators to gain unauthorized access to computers and computer networks and for intentional or inadvertent disclosure of sensitive information.

In a cloud computing system, confidential information is stored, transmitted, and used by many different information processing systems. Techniques have been developed to provide for the secure handling and storing of confidential information. These techniques include various approaches to creating and maintaining a secured, protected, or isolated partition or environment within an information processing system. However, some of these techniques do not address the issue of securing data. What is needed is system that can secure data in a cloud network.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a communication system for enabling data security in a cloud network in accordance with an embodiment of the present disclosure;

FIG. 1B is a simplified block diagram of a communication system for enabling data security in a cloud network in accordance with an embodiment of the present disclosure;

FIG. 2 is a simplified block diagram of example details of a portion of a communication system for enabling data security in a cloud network in accordance with an embodiment of the present disclosure;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a block diagram illustrating an example computing system that is arranged in a point-to-point configuration in accordance with an embodiment;

FIG. 7 is a simplified block diagram associated with an example ecosystem system on chip (SOC) of the present disclosure; and

FIG. 8 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

The following detailed description sets forth example embodiments of apparatuses, methods, and systems relating to a communication system for device pairing in a local network. Features such as structure(s), function(s), and/or characteristic(s), for example, are described with reference to one embodiment as a matter of convenience; various embodiments may be implemented with any suitable one or more of the described features.

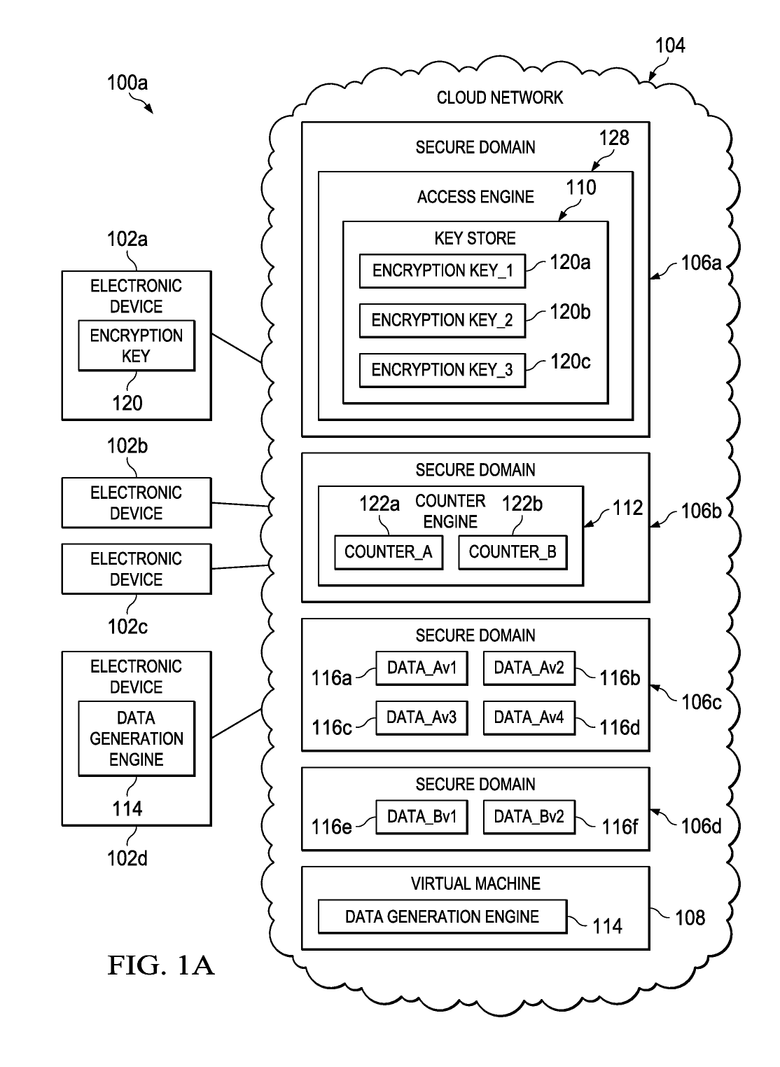

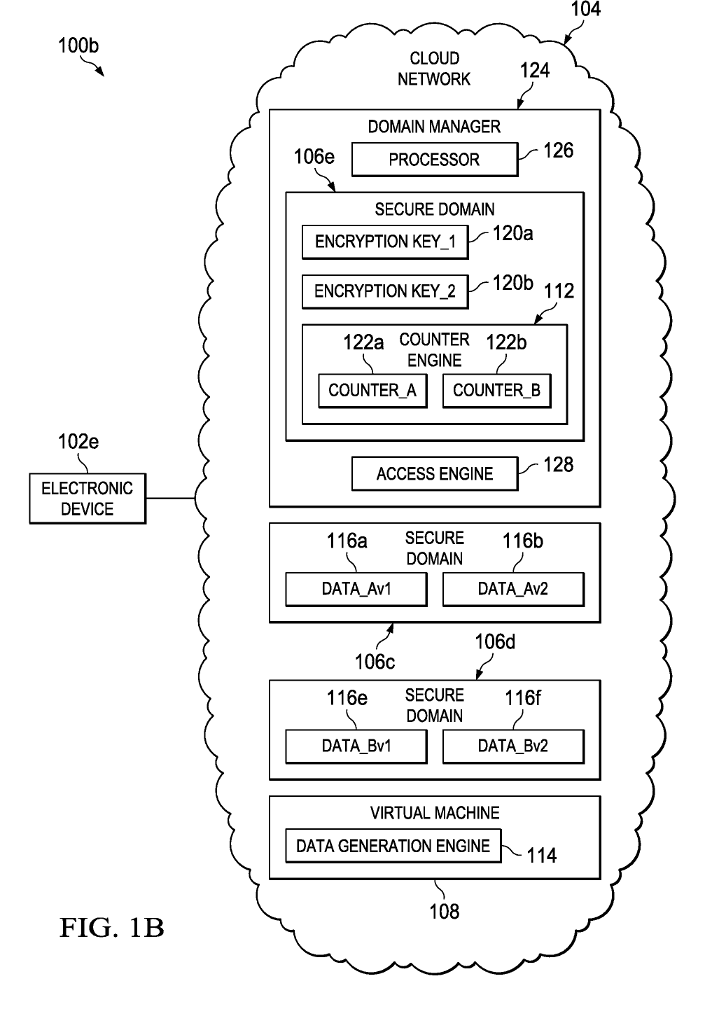

FIG. 1A is a simplified block diagram of a communication system 100a for enabling data security in a cloud network in accordance with an embodiment of the present disclosure. Communication system 100a can include one or more electronic devices 102a-102d and a cloud network 102. Electronic device 102a can include an encryption key 120. Electronic device 102d can include data generation engine 114

Cloud network 104 can include one or more secure domains 106a-106d and a virtual machine 108. Secure domain 106a can include an access engine 128. Access engine 128 can include a key store 110. Key store 110 can include one or more encryption keys 120a-120c. Secure domain 106b can include a counter engine 112. Counter engine 112 can include one or more counters 122a and 122b. Secure domain 106c can include one or more instances of data 116a-116d. Secure domain 106d can include one or more instances of data 116e and 116f. Virtual machine 108 can include data generation engine 114. Data 116a-116d may be different versions of data, such as a document that has undergone revisions (e.g., data_Av1 116a is the original document, data_Av2 116b is a revised document based off data_Av1 116a, etc.). Counter_A 122a can be configured to keep track of the most current draft or most current data from data 116a-116d (e.g., counter_A 122a can be used to determine that data_Av4 116d is the most current data). Data generation engine 114 can generate data such as measurements from an experiment. In an example, cloud network 104 is a portion of a cloud computing system.

Turning to FIG. 1B, FIG. 1B is a simplified block diagram of a communication system 100b for enabling data security in a cloud network in accordance with an embodiment of the present disclosure. Communication system 100b can include electronic device 10e and cloud network 104. Electronic device 102a can include an encryption key 120. Electronic device 102d can include data generation engine 114.

Cloud network 104 can include one or more secure domains 106c and 106d, virtual machine 108, and a domain manger 124. Domain manager 124 can include secure domain 106e, a processor 126, and access engine 128. Secure domain 106e can include counter engine 112 and one or more encryption keys 120a and 120b. Counter engine 112 can include one or more counters 122a and 122b. Access engine 128 can facilitate access to secure domain 106e, encryption keys 120a and 120b, and counter engine 112 and help ensure only authorized devise are allowed to access secure domain 106e, encryption keys 120a and 120b, and counter engine 112. In an example, access engine 128 can operate similar to access engine 110. In an example, cloud network 104 is a portion of a cloud computing system.

Elements of FIGS. 1A and 1B may each be coupled to one another through one or more interfaces employing any suitable connections (wired or wireless), which provide viable pathways for network communications. Additionally, any one or more of these elements of FIGS. 1A and 1B may be combined or removed from the architecture based on particular configuration needs. Communication systems 100a and 100b may include a configuration capable of transmission control protocol/Internet protocol (TCP/IP) communications for the transmission or reception of packets in a network. Communication systems 100a and 100b may also operate in conjunction with a user datagram protocol/IP (UDP/IP) or any other suitable protocol where appropriate and based on particular needs.

In an example, communication systems 100a and 100b can each be configured to include a system that allows for data security in a cloud network. In an example, in a cloud network electronic device can be configured to store data in a secure domain in a cloud network, create encryption keys, where each encryption key is to provide a different type of access to the data, and store the encryption keys in a secure domain key store in the cloud network. In an example, each encryption key provides access to a different version of the data. In another example, a counter engine stores the location of each version of the data in the cloud network. In an illustrative example, data can be stored in a secure domain and access to the data can be granted using access keys. Each access key can have a different level of access to the data. In an example, each access key can provide access to a different version or draft of the data. The encryption keys can be stored in a secure domain. In an example, a generator of the data can create the encryption keys and provide policies regarding the encryption keys where the policies include the level of access provided by each key as well as the version of the data.

For purposes of illustrating certain example techniques of communication systems 100a and 100b, it is important to understand the communications that may be traversing the network environment. The following foundational information may be viewed as a basis from which the present disclosure may be properly explained.

End users have more communications choices than ever before. A number of prominent technological trends are currently afoot (e.g., more computing devices, more connected devices, etc.). One current trend is using a network, especially using a cloud based network computing system. Cloud networking is a networking paradigm for building and managing secure private networks over the public Internet by utilizing a global cloud computing infrastructure. In cloud networking, traditional network functions and services including connectivity, security, management and control, are pushed to the cloud and delivered as a service. Cloud-based networks only require an Internet connection and work over any physical infrastructure, wired or wireless, public or private. One key concern with cloud networks is data security. What is needed is a system that can be configured to provide data security in a cloud network.

A communication system that can provide data security in a cloud network, as outlined in FIGS. 1A and 1B, can resolve these issues (and others). In an example, a key store (e.g., key store 110) can provide access to encryption keys (e.g., encryption key_1 120a) to allow a cloud component or electronic device (e.g., electronic device 102a or 102b) to access data (e.g., data_Av1). Access to key store 110 can be monitored by an access engine (e.g., access engine 110) such that only authorized devices are allowed to access the encryption key and the data. In addition, a counter engine (e.g., counter engine 112) can track the latest version of the data as well as previous versions of the data. The counter engine can be configured to help provide a version of the data that the device is allowed to access. For example, electronic device 102b may be allowed to access the most recent version of data (e.g., data_Bv2 116f) while electronic device 102c may only be allowed to access an earlier version of the data (e.g., data_Bv1 116e). By using a counter engine to point or otherwise identify different versions of the same data, memory can be conserved. For example, storing data 116a-116d in secure domain 106d would take a relatively large amount of storage in secure domain 106b. However, counter_A 112a in counter engine 112 can be configured to track each version of the data and counter_A 112a would take up a relatively small amount of storage in secure domain 106b. In an example, counter_A 112a only gives an indication of the most recent version of data in secure domain 106c (e.g., data_Av4 116d) and counter_B 112b only gives an indication of the most recent version of data in secure domain 106d (e.g., data_Bv2 116f).

In an example, a platform service may include a secure domain that can communicate with a plurality of virtual machines on the platform service and can provide each virtual machine with a current counter to identify the latest version of data on the platform service. As a result, data does not need to be stored on a specific server or in a specific location and the secure domain can direct devices or cloud components on the platform service to the most recent version of data. In a specific example, a page size extension (PSE) can communicate with counter engine 112 and obtain a latest version of data.

In another example, confidential data is created (e.g., by a user of electronic device 102a or by data generation engine 114) and the data can be stored in a secure domain (e.g., secure domain 106c) on a cloud network (e.g., cloud network 104). Access to the data can be stored in a key store (e.g., key store 110) that is protected by an access engine (e.g., access engine 128). In an example, an encryption key (e.g., encryption key_1 120a) can be created to protect the data. In another example, the encryption key can be provided by the electronic device (e.g., encryption key 120). A counter service can be initialized for the data (e.g., using counter engine 112) and policies can be created regarded what version of the data can be communicated to a specific device. In addition, policies can also be created in regards as to what is allowed to be done with the data. For example, electronic device 102a may be allowed to access encryption key_1 120a and can have full access to the most recent data and can modify, delete, copy, etc. Electronic device 102b may be allowed to access encryption key_2 120b and have access to the most recent data, but encryption key_2 120b may only allow reading of the data and not modifying or copying of the data. Electronic device 102c may be allowed to access encryption key_3 120c and have access to an older version of the data (e.g., data_Av2 116b) and encryption key_3 120c may only allow electronic device 102c to read and copy or download the data but not modify the data.

Turning to the infrastructure of FIG. 1, communication system 100 in accordance with an example embodiment is shown. Generally, communication system 100 can be implemented in any type or topology of networks. Cloud network 104 represent a series of points or nodes of interconnected communication paths for receiving and transmitting packets of information that propagate through communication system 100. Cloud network 104 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a cloud network environment, or any suitable combination thereof, including wired and/or wireless communication.

In communication systems 100a and 100b, network traffic, which is inclusive of packets, frames, signals (analog, digital or any combination of the two), data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications (e.g., over a cellular network) may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, secure domains 106a-106e and virtual machine 108 are cloud network elements, which are meant to encompass network appliances, servers (both virtual and physical), routers, switches, gateways, bridges, load balancers, processors, modules, or any other suitable virtual or physical device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a cloud network environment. This may be inclusive of appropriate algorithms and communication protocols that allow for the effective exchange of data or information.

In regards to the internal structure associated with communication systems 100a and 100b, each of electronic devices 102a-102d, secure domains 106a-106e, and virtual machine 108 can include memory elements for storing information to be used in the operations outlined herein. Each of electronic devices 102a-102d, secure domains 106a-106e, and virtual machine 108 may keep information in any suitable memory element (e.g., random access memory (RAM), read-only memory (ROM), erasable programmable ROM (EPROM), electrically erasable programmable ROM (EEPROM), application specific integrated circuit (ASIC), non-volatile memory (NVRAM), magnetic storage, magneto-optical storage, flash storage (SSD), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication systems 100a and 100b could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication systems 100a and 100b, such as electronic devices 102a-102d, secure domains 106a-106e, and virtual machine 108 may include software modules (e.g., counter engine 112, data generation engine 114, and access engine 128) to achieve, or to foster, operations as outlined herein. These modules may be suitably combined in any appropriate manner, which may be based on particular configuration and/or provisioning needs. In some embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic devices 102a-102d, secure domains 106a-106e, and virtual machine 108 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic devices 102a-102d, secure domains 106a-106e, and virtual machine 108 can be networks elements and include, for example, physical or virtual servers or other similar devices that may be used in a cloud services architecture. Cloud network 104 may generally be defined as the use of computing resources that are delivered as a service over a network, such as the Internet. The services may be distributed and separated to provide required support for electronic devices. Typically, compute, storage, and network resources are offered in a cloud infrastructure, effectively shifting the workload from a local network to the cloud network. A server can be a network element such as a server or virtual server and can be associated with clients, customers, endpoints, or end users wishing to initiate a communication in communication systems 100a and 100b via some network. The term ‘server’ is inclusive of devices used to serve the requests of clients and/or perform some computational task on behalf of clients within communication systems 100a and 100b.

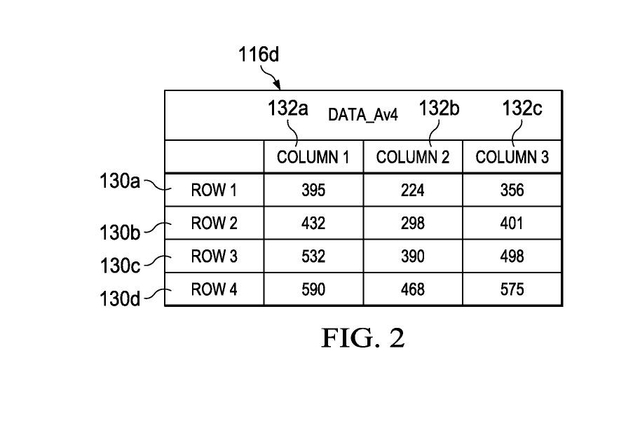

Turning to FIG. 2, FIG. 2 is a simplified block diagram of example details of a portion of a communication system for enabling data security in a cloud network in accordance with an embodiment of the present disclosure. In an example, electronic device 102a (not shown) may be allowed to access data_Av4 116d using encryption key_1 120a. Encryption key_1 120a allows electronic device 102a to have full access to data_Av4 116d meaning electronic device 120a can read, copy modify, etc. rows 130a-130d and columns 132a-132c. Electronic device 102b (not shown) may be allowed to access data_Av4 116d using encryption key_1 120b. Encryption key_1 120b allows electronic device 102b to have limited access to data_Av4 116d meaning electronic device 120a can read, copy, or download only rows 130a-130c in columns 132a and 132b. Electronic device 102c (not shown) may be allowed to access data_Av4 116d using encryption key_1 120c. Encryption key_1 120c allows electronic device 102c to have very limited access to data_Av4 116d meaning electronic device 120c can only read row 130a and column 132a. The amount of access provided by each encryption key described above is for illustration purposes only and can be configured to an administrator's preference with a plurality of encryption keys allowing various types of access.

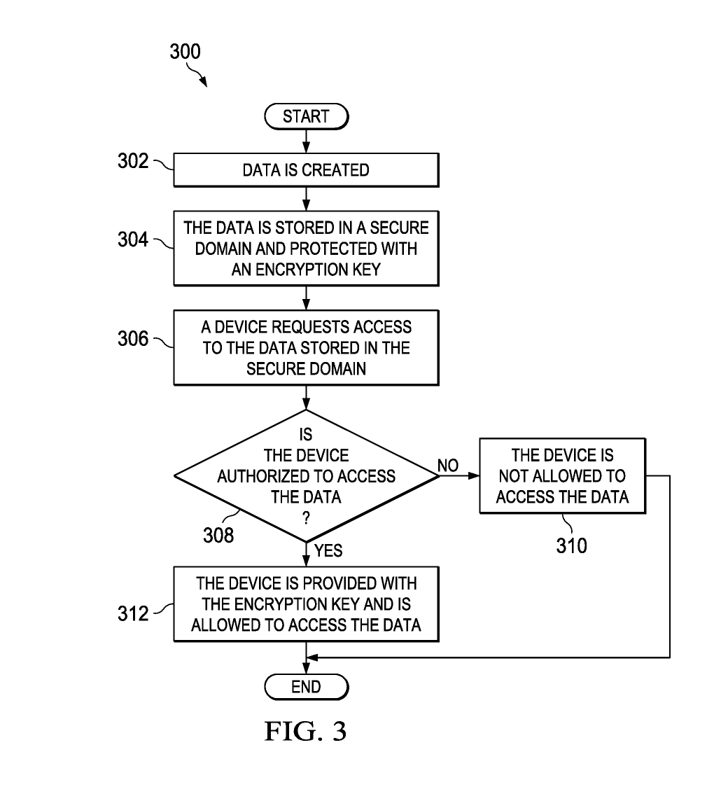

Turning to FIG. 3, FIG. 3 is an example flowchart illustrating possible operations of a flow 300 that may be associated with data security in a cloud network, in accordance with an embodiment. In an embodiment, one or more operations of flow 300 may be performed by one or more of counter engine 112, data generation engine 114, and access engine 128. At 302, data is created. At 304, the data is stored in a secure domain and protected with an encryption key. At 306, a device requests access to the data stored in the secure domain. At 308, the system determines if the device is authorized to access the data. If the device is not allowed to access the data, then the device is not allowed to access the data, as in 310. If the device is allowed to access the data, then the device is provided with the encryption key and is allowed to access the data.

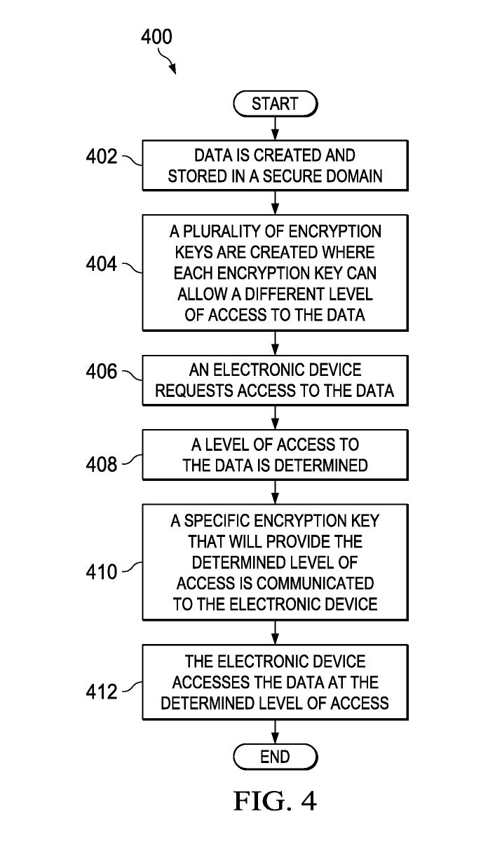

Turning to FIG. 4, FIG. 4 is an example flowchart illustrating possible operations of a flow 400 that may be associated with data security in a cloud network, in accordance with an embodiment. In an embodiment, one or more operations of flow 400 may be performed by one or more of counter engine 112, data generation engine 114, and access engine 128. At 402, data is created and stored in a secure domain. At 404, a plurality of encryption keys are created where each encryption key can allow a different level of access to the data. At 406, an electronic device requests access to the data. At 408, a level of access to the data is determined. At 410, a specific encryption key that will provide the determined level of access is communicated to the electronic device. At 412, the electronic device accesses the data at the determined level of access.

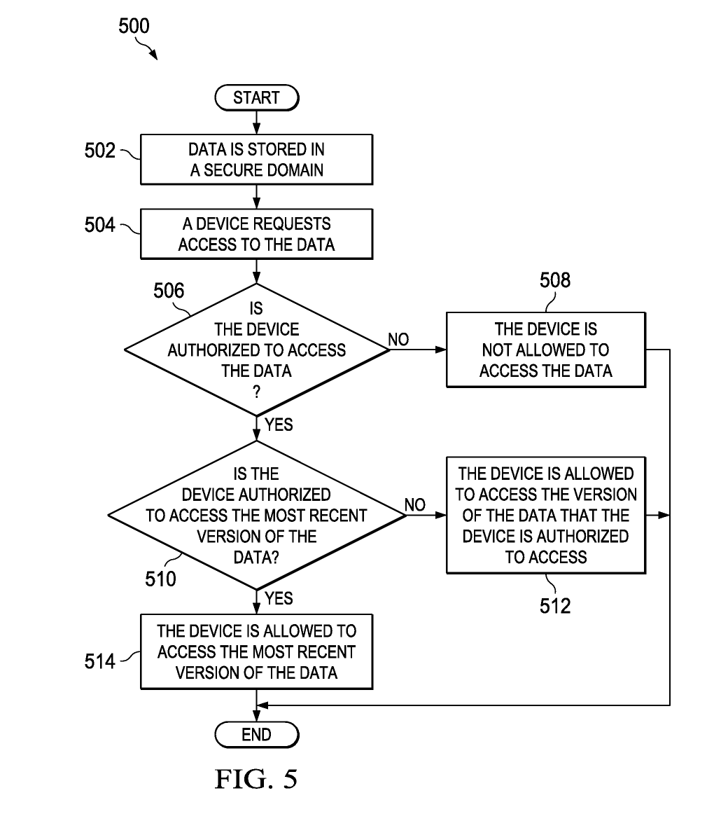

Turning to FIG. 5, FIG. 5 is an example flowchart illustrating possible operations of a flow 500 that may be associated with data security in a cloud network, in accordance with an embodiment. In an embodiment, one or more operations of flow 500 may be performed by one or more of counter engine 112, data generation engine 114, and access engine 128. At 502, data is stored in a secure domain. At 504, a device requests access to the data. At 506, the system determines if the device is authorized to access the data. If the device is not authorized to access the data, then the device is not allowed to access the data, as in 508. If the device is allowed to access the data, then the system determines if the device is authorized to access the most recent version of the data, as in 510. If the device is not allowed to access the most recent version of the data, then the device is authorized to access the version of the data that the device is authorized to access, as in 512. If the device is authorized to access the most recent version of the data, then the device is allowed to access the most recent version of the data.

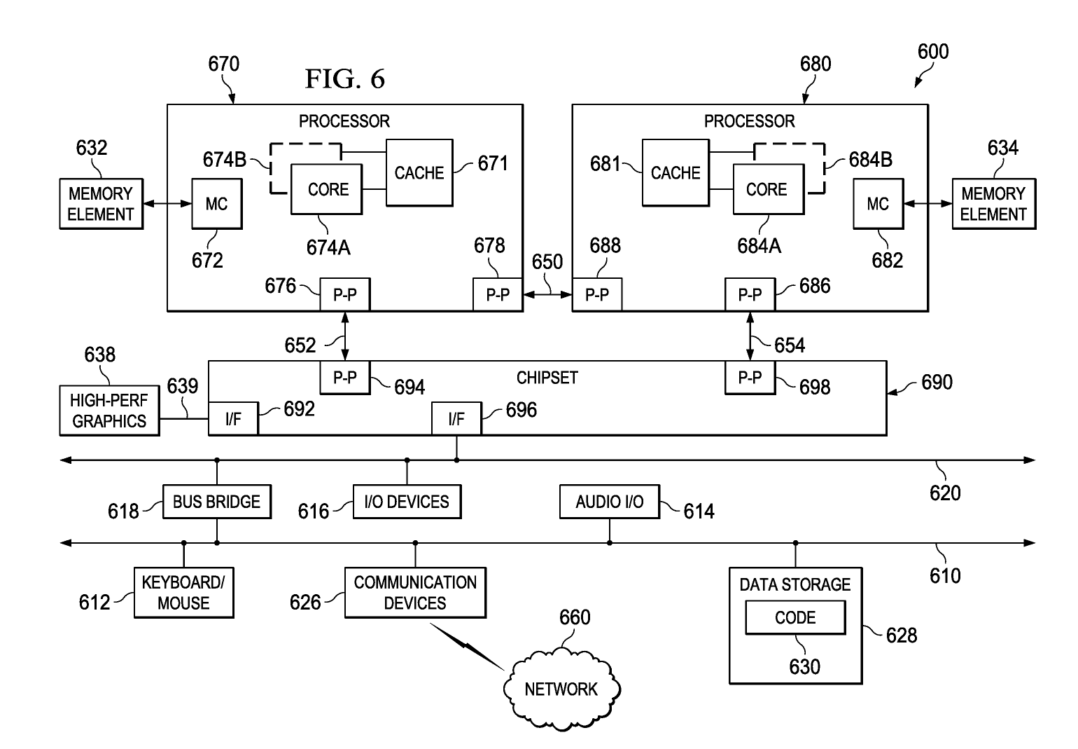

Turning to FIG. 6, FIG. 6 illustrates a computing system 600 that is arranged in a point-to-point (PtP) configuration according to an embodiment. In particular, FIG. 6 shows a system where processors, memory, and input/output devices are interconnected by a number of point-to-point interfaces. Generally, one or more of the network elements of communication system 100 may be configured in the same or similar manner as computing system 600.

As illustrated in FIG. 6, system 600 may include several processors, of which only two, processors 670 and 680, are shown for clarity. While two processors 670 and 680 are shown, it is to be understood that an embodiment of system 600 may also include only one such processor. Processors 670 and 680 may each include a set of cores (i.e., processor cores 674A and 674B and processor cores 684A and 684B) to execute multiple threads of a program. The cores may be configured to execute instruction code in a manner similar to that discussed above with reference to FIGS. 1-5. Each processor 670, 680 may include at least one shared cache 671, 681. Shared caches 671, 681 may store data (e.g., instructions) that are utilized by one or more components of processors 670, 680, such as processor cores 674 and 684.

Processors 670 and 680 may also each include integrated memory controller logic (MC) 672 and 682 to communicate with memory elements 632 and 634. Memory elements 632 and/or 634 may store various data used by processors 670 and 680. In alternative embodiments, memory controller logic 672 and 682 may be discrete logic separate from processors 670 and 680.

Processors 670 and 680 may be any type of processor and may exchange data via a point-to-point (PtP) interface 650 using point-to-point interface circuits 678 and 688, respectively. Processors 670 and 680 may each exchange data with a chipset 690 via individual point-to-point interfaces 652 and 654 using point-to-point interface circuits 676, 686, 694, and 698. Chipset 690 may also exchange data with a high-performance graphics circuit 638 via a high-performance graphics interface 639, using an interface circuit 692, which could be a PtP interface circuit. In alternative embodiments, any or all of the PtP links illustrated in FIG. 6 could be implemented as a multi-drop bus rather than a PtP link.

Chipset 690 may be in communication with a bus 620 via an interface circuit 696. Bus 620 may have one or more devices that communicate over it, such as a bus bridge 618 and I/O devices 616. Via a bus 610, bus bridge 618 may be in communication with other devices such as a keyboard/mouse 612 (or other input devices such as a touch screen, trackball, etc.), communication devices 626 (such as modems, network interface devices, or other types of communication devices that may communicate through a computer network 660), audio I/O devices 614, and/or a data storage device 628. Data storage device 628 may store code 630, which may be executed by processors 670 and/or 680. In alternative embodiments, any portions of the bus architectures could be implemented with one or more PtP links.

The computer system depicted in FIG. 6 is a schematic illustration of an embodiment of a computing system that may be utilized to implement various embodiments discussed herein. It will be appreciated that various components of the system depicted in FIG. 6 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

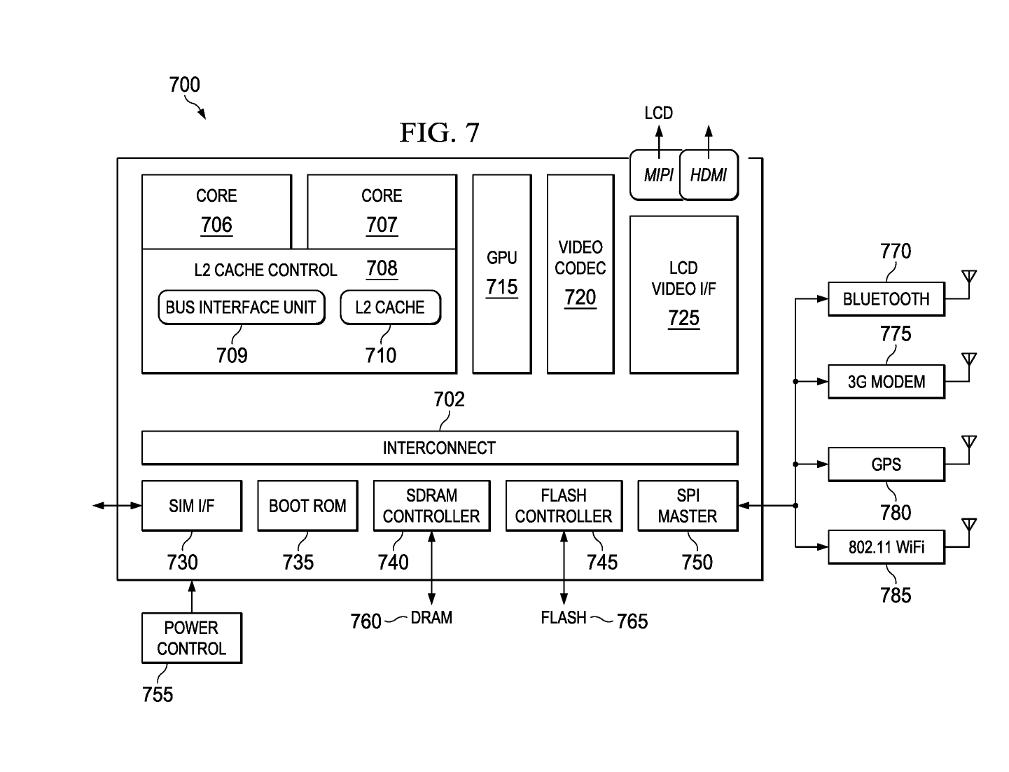

Turning to FIG. 7, FIG. 7 is a simplified block diagram associated with an example ecosystem SOC 700 of the present disclosure. At least one example implementation of the present disclosure can include the device pairing in a local network features discussed herein. Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 7, ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LCD.

Ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more embodiments include one or more communication capabilities, interfaces, and features such as instances of Bluetooth™ 770, a 3G modem 775, a global positioning system (GPS) 780, and an 802.11 Wi-Fi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

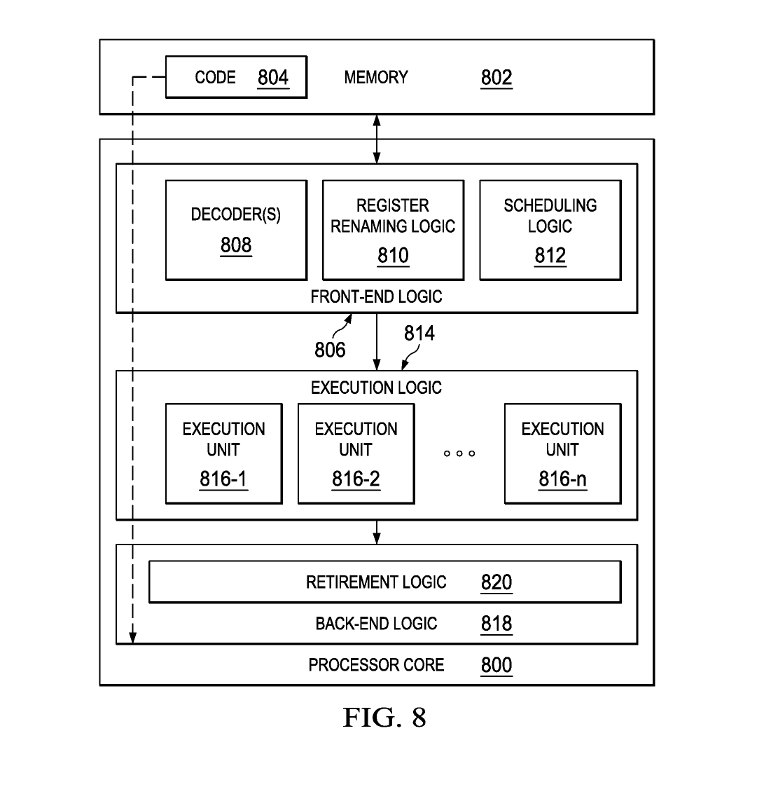

FIG. 8 illustrates a processor core 800 according to an embodiment. Processor core 800 may be the core for any type of processor, such as a micro-processor, an embedded processor, a digital signal processor (DSP), a network processor, or other device to execute code. Although only one processor core 800 is illustrated in FIG. 8, a processor may alternatively include more than one of the processor core 800 illustrated in FIG. 8. For example, processor core 800 represents one example embodiment of processors cores 874a, 874b, 884a, and 884b shown and described with reference to processors 870 and 880 of FIG. 8. Processor core 800 may be a single-threaded core or, for at least one embodiment, processor core 800 may be multithreaded in that it may include more than one hardware thread context (or “logical processor”) per core.

FIG. 8 also illustrates a memory 802 coupled to processor core 800 in accordance with an embodiment. Memory 802 may be any of a wide variety of memories (including various layers of memory hierarchy) as are known or otherwise available to those of skill in the art. Memory 802 may include code 804, which may be one or more instructions, to be executed by processor core 800. Processor core 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor core 800 can also include execution logic 814 having a set of execution units 816-1 through 816-N. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor core 800 allows out of order execution but requires in order retirement of instructions. Retirement logic 820 may take a variety of known forms (e.g., re-order buffers or the like). In this manner, processor core 800 is transformed during execution of code 804, at least in terms of the output generated by the decoder, hardware registers and tables utilized by register renaming logic 810, and any registers (not shown) modified by execution logic 814.

Although not illustrated in FIG. 8, a processor may include other elements on a chip with processor core 800, at least some of which were shown and described herein with reference to FIG. 6. For example, as shown in FIG. 6, a processor may include memory control logic along with processor core 800. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 and as potentially applied to a myriad of other architectures.

It is also important to note that the operations in the preceding flow diagrams (i.e., FIGS. 3-5) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable medium having one or more instructions that when executed by at least one processor cause the at least one processor to store data in a secure domain in a cloud network, create encryption keys, wherein each encryption key provides a different type of access to the data, and store the encryption keys in a secure domain key store in the cloud network.

In Example C2, the subject matter of Example C1 can optionally include where each encryption key provides access to a different version of the data.

In Example C3, the subject matter of any one of Examples C1-C2 can optionally include where a generator of the data creates the encryption keys and communicates the encryption keys to the secure domain key store.

In Example C4, the subject matter of any one of Examples C1-C3 can optionally include where an access control engine controls access to the encryption keys.

In Example C5, the subject matter of any one of Examples C1-C4 can optionally include where a counter engine stores the location of each version of the data in the cloud network.

In Example A1, an apparatus can include an access engine, where the access engine is configured to store data in a secure domain in a cloud network, create encryption keys, wherein each encryption key is to provide a different type of access to the data, and store the encryption keys in a secure domain key store in the cloud network.

In Example, A2, the subject matter of Example A1 can optionally include where each encryption key provides access to a different version of the data.

In Example A3, the subject matter of any one of Examples A1-A2 can optionally include where a generator of the data creates the encryption keys and communicates the encryption keys to the access engine.

In Example A4, the subject matter of any one of Examples A1-A3 can optionally further include a counter engine, where the counter engine is configured to store the location of each version of the data in the cloud network.

In Example A5, the subject matter of any one of Examples A1-A4 can optionally include where the counter engine is located in a second secure domain that is separate from the secure domain where the data is stored.

Example M1 is a method including storing data in a secure domain in a cloud network, creating encryption keys, where each encryption key is to provide a different type of access to the data, and storing the encryption keys in a secure domain key store in the cloud network.

In Example M2, the subject matter of Example M1 can optionally include where each encryption key provides access to a different version of the data.

In Example M3, the subject matter of any one of the Examples M1-M2 can optionally include where a generator of the data creates the encryption keys and communicates the encryption keys to the secure domain key store.

In Example M4, the subject matter of any one of the Examples M1-M3 can optionally include where an access control engine controls access to the encryption keys.

In Example M5, the subject matter of any one of the Examples M1-M4 can optionally include where a counter engine stores the location of each version of the data in the cloud network.

Example S1 is a system for providing data security in a cloud network, the system can include an access engine, where the access engine is configured to store data in a secure domain in a cloud network, create encryption keys, where each encryption key is to provide a different type of access to the data, and store the encryption keys in a secure domain key store in the cloud network.

In Example S2, the subject matter of Example S1 can optionally include where each encryption key provides access to a different version of the data.

In Example S3, the subject matter of any of the Examples S1-S2 can optionally include where a generator of the data creates the encryption keys and communicates the encryption keys to the access engine.

In Example S4, the subject matter of any of the Examples S1-S2 can optionally include a counter engine, where the counter engine is configured to store the location of each version of the data in the cloud network.

In Example S5 the subject matter of any of the Examples S1-S2 can optionally include where.

Example X1 is a machine-readable storage medium including machine-readable instructions to implement a method or realize an apparatus as in any one of the Examples A1-A5, or M1-M5. Example Y1 is an apparatus comprising means for performing of any of the Example methods M1-M5. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine readable medium comprising one or more instructions that when executed by at least one processor, cause the at least one processor to:
store data in a secure domain in a cloud network;
create encryption keys, wherein each encryption key is to provide a different type of access to the data; and
store the encryption keys in a secure domain key store in the cloud network.

2. The at least one machine readable medium of claim 1, wherein each encryption key provides access to a different version of the data.

3. The at least one machine readable medium of claim 1, wherein a generator of the data creates the encryption keys and communicates the encryption keys to the secure domain key store.

4. The at least one machine readable medium of claim 1, wherein an access control engine controls access to the encryption keys.

5. The at least one machine readable medium of claim 1, wherein a counter engine stores the location of each version of the data in the cloud network.

6. An apparatus comprising:
an access engine, wherein the access engine is configured to:
store data in a secure domain in a cloud network;
create encryption keys, wherein each encryption key is to provide a different type of access to the data; and
store the encryption keys in a secure domain key store in the cloud network.

7. The apparatus of claim 6, wherein each encryption key provides access to a different version of the data.

8. The apparatus of claim 6, wherein a generator of the data creates the encryption keys and communicates the encryption keys to the access engine.

9. The apparatus of claim 6, further comprising a counter engine, wherein the counter engine is configured to:
store the location of each version of the data in the cloud network.

10. The apparatus of claim 9, wherein the counter engine is located in a second secure domain that is separate from the secure domain where the data is stored.

11. A method comprising:
storing data in a secure domain in a cloud network;
creating encryption keys, wherein each encryption key is to provide a different type of access to the data; and
storing the encryption keys in a secure domain key store in the cloud network.

12. The method of claim 11, wherein each encryption key provides access to a different version of the data.

13. The method of claim 11, wherein a generator of the data creates the encryption keys and communicates the encryption keys to the secure domain key store.

14. The method of claim 11, wherein an access control engine controls access to the encryption keys.

15. The method of claim 11, wherein a counter engine stores the location of each version of the data in the cloud network.

16. A system for providing data security in a cloud network, the system comprising:
an access engine, wherein the access engine is configured to:
store data in a secure domain in a cloud network;
create encryption keys, wherein each encryption key is to provide a different type of access to the data; and
store the encryption keys in a secure domain key store in the cloud network.

17. The system of claim 16, wherein each encryption key provides access to a different version of the data.

18. The system of claim 16, wherein a generator of the data creates the encryption keys and communicates the encryption keys to the access engine.

19. The system of claim 16, further comprising a counter engine, wherein the counter engine is configured to:
store the location of each version of the data in the cloud network.

20. The system of claim 19, wherein the counter engine is located in a second secure domain that is separate from the secure domain where the data is stored.
